(19) United States
(12) Patent Application Publication
(10) Pub. No.: US 2006/0241810 A1
(43) Pub. Date: Oct. 26, 2006

(54) High stiffness, high accuracy, parallel kinematic, three degree of freedom motion platform

(76) Inventors: Dan Zhang, Whitby (CA); Sherman Y. T. Lang, London (CA); Peter Orban, London (CA); Zhuming Bi, London (CA); Marcel Verner, London (CA); Stan Kowala, London (CA); David W. Kingston, London (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(21) Appl. No.: 11/395,287

(22) Filed: Apr. 3, 2006

Related U.S. Application Data
(60) Provisional application No. 60/672,854, filed on Apr. 20, 2005.

(51) Int. Cl. G06F 19/00

(52) U.S. Cl. 700/245

(57) ABSTRACT

A parallel kinematic machine (PKM) with three active kinematic chains and a leg has improved precision and stiffness maps by: providing drive and actuation of each active kinematic chain by devices secured rigidly to a support structure so that only a fixed length leg of the chain is suspended; driving the fixed length leg of the active kinematic chain to move in a direction oblique to a direction of the fixed length leg; and providing a prismatically jointed leg that is rigidly secured to the base structure and coupled by an effectively universal joint to the motion platform.

This application claims benefit of U.S. Provisional Patent Application 60/672,854 filed Apr. 20, 2005.

### FIELD OF THE INVENTION

This invention relates in general to Parallel Kinematic Machines (PKM) for precision machining, motion, locating, positioning, fixturing, and more particularly to a PKM for use in a machine having greater stiffness and accuracy when subjected to greater loads.

### BACKGROUND OF THE INVENTION

Kinematic chains that control position and orientation of a motion platform (typically an adapter for coupling to one or more tools or fixtures) to a rigid support in use today are typically serial jointed mechanisms. For example, conventional orthogonal multi-axis machines are known that control motion of the platform with three degrees of freedom, have three axes arranged as three mutually orthogonal beams. One axis is laid upon the other serially. Unfortunately the inertia of a tool supported by a multi-axis machine is generally large because of the distance of the tool to the axis of the beam that is secured to the ground, and because of the weights of the other successively supported orthogonal beams. Furthermore the tolerance of positioning of the platform and tool is the sum of tolerances in each joint, making it expensive to provide high precision machining and positioning.

For this reason systems have been developed using parallel kinematic machines. A PKM is a collection of kinematic chains connecting the motion platform to a support structure in parallel (i.e. independently). Typically each kinematic chain consists of a sequence of rigid pieces (legs or links) jointed together. If a kinematic chain includes an actuable, driven element, the kinematic chain is an active chain; otherwise it is a passive kinematic chain. By providing two or more parallel (i.e. independent) kinematic chains, the position and orientation of the end effector may be controlled with varying degrees of freedom, but the tolerance of the motion platform is limited only to that of the kinematic chain that introduces the greatest error.

Unfortunately, applications of PKM technology in high precision machine contexts has been limited to applications involving relatively low loads applied to the motion platform, and to applications for which loads are accommodated in limited directions (e.g. axially but not transversely), to applications in which the motion platform is constrained to move within a more limited range of positions and orientations, and/or to applications where lower precision is acceptable, or alternatively require more expensive and bulky equipment. In order to provide improved accuracy, larger legs of greater cross-section and more powerful actuators need to be used. This is because larger, more expensive, and bulkier kinematic links need to be provided in order to ensure that an adequate stiffness (i.e. the resistance of the motion platform to yield to stresses applied in respective directions, as a function of position and orientation of the motion platform) is provided for the precision operations (e.g. machining, milling, grinding, polishing, finishing, locating, positioning, fixturing, and assembly) over the range of positions, orientations and motions of the motion plate.

For example, U.S. Pat. No. 6,431,802 to Wahl teaches a universal-joint tool head having a platform which can move in three axes, two pivoting and one linear axis. The tool head includes at least three connecting rods which are articulatedly mounted on the tool platform, and can be moved independently of one another, at least three linear-movement devices, which are arranged around and at a distance from the tool platform, and are parallel to one another, for the connecting rods articulatedly mounted thereon. The connecting rods are mounted on the platform in such a manner that they can move on all sides, and on the linear-movement devices in such a manner that they can pivot about pins running perpendicular to the direction of movement of the linear-movement devices.

Applicant's research has shown that while such configurations provide adequate stiffness in an axial direction, for a limited range of orientations of the motion plate to enable certain operations, they cannot provide the stiffness and/or precision to permit those machining operations to be applied over a wider range of positions and orientation, and generally provide insufficient stiffness in transverse directions.

Numerous other designs of PKMs are known, including some that provide sliding blocks connected by a rail to a base and inclined at an angle from the base toward a nominal axis of the PKM. For example, a well known configuration of PKM referred to as George V designed by the University of Hanover. Furthermore, examples of PKM designs are known that provide a passive kinematic chain including a free-moving telescoping leg that is mounted to the support structure by universal joint (i.e. a 2-degree of freedom joint consisting of a pair of orthogonally oriented revolute joints, both of which are perpendicular to an axis of the leg), and rigidly mounted to the motion platform. In such embodiments, the number of effective degrees of freedom of each active leg is increased by one. U.S. Pat. No. 4,732,525 to Neumann illustrates one such PKM configuration with a passive leg.

U.S. Pat. No. 5,740,699 to Ballantyne et al. teaches a wrist joint, as are typically used in the field of robotics. For this reason, the stiffness of the end effector is not of concern. Ballantyne et al. discloses an extendible wrist mechanism having a base and a spaced end plate to which an end effector or other tool holder may be mounted. Three linear actuators are disposed about the central axis directed from the base to the end plate. Each actuator is joined to the base by a universal joint. Each linear actuator is mounted to the end plate by a joint permitting pitch, yaw, and roll of the end member with respect to the linear actuator. A tube extends from the base and telescopingly receives a member which is attached to the end plate at the central axis by a U-joint permitting pitch and yaw of the end plate. The base mounted tube is keyed to the end plate mounted member so that the end plate is held against rotation with respect to the base. It will be appreciated by those of skill in the art that the wrist joint according to Ballantyne et al. does not provide a structure suitable for supporting a load that is suitable for precision machining, and the passive leg provided by the telescoping tube and member is merely provided to isolate the end plate from axial rotation and transverse translation.

There therefore remains a need for a PKM that provides a motion platform with higher stiffnesses and/or accuracies at a wider range of positions and orientations.

### SUMMARY OF THE INVENTION

Accordingly a PKM is provided that controls a motion platform, providing higher stiffnesses and/or accuracies at a wider range of positions and orientations.

Therefore a PKM is provided for controlling position and orientation of a motion platform, the PKM including a base structure, three active kinematic chains, a passive leg, and a motion platform. Each of the three active kinematic chains includes a fixed length leg coupled at a first end by an effectively spherical joint to a respective point on the motion platform, and coupled at a second end to a sliding carriage mounted to the base structure. The passive leg is a prismatically jointed leg coupled at one end to a motion platform by an effectively universal joint, and rigidly secured to the base structure. The base structure secures one drive motor, one actuator, and one guide for each of the active kinematic chains, each actuator being coupled to the corresponding carriage that is slidably mounted to the corresponding guide, which guide constrains the carriage to move in a direction oblique to a direction of motion of the corresponding fixed length leg.

Accordingly the PKM has the following features:
1. a drive motor, actuator, and guide of each of three active kinematic chains being rigidly secured to a base structure;
2. the drive motor and actuator controls a carriage that is constrained by the guide to move in a direction oblique to a direction of motion of a fixed length leg that is connected to the carriage by an effectively universal joint and connected to the motion platform by an effectively spherical joint; and
3. the passive leg that is fixedly mounted to the base structure and mounted by what is effectively a universal joint to the motion platform.

Because of the first feature, the weight of the drive components is carried entirely by the base structure and not by the kinematic links. Accordingly the inertia and intrinsic load of the kinematic links are minimized. The active components are also maximally separated from the motion platform, which may be useful when shielding of the active components is desired. Furthermore, as the driven components are statically held by the base structure, there is no tolerance of a joint that mounts the driven components to the support structure to contend with. Accordingly misalignment and off-axis forces that impair and increase wear on the driven components is minimized.

Because of the second feature, in contrast to extensible leg configurations where the kinematic chains are actuated by delivering a linearly directed force in a direction of the fixed leg, both finer control of the extensible leg can be provided to increase the precision of control of the motion platform, and a stiffness of the motion platform can be improved, as it is provided, in part, by the strength of the guide and the base structure. Using extensible leg configurations, one unit of motion of the actuator corresponds to one unit of motion on the motion platform. As a corollary, the strength of the kinematic chain is equal to the strength of the actuator and drive system, and the degree of control over the position of the motion platform is the degree of control of the actuator and drive system. In contrast, when the drive system and actuator provide a motion in a direction that is oblique to the direction of the motion of the fixed length leg, one unit of motion of the carriage corresponds to a fraction of the unit of motion at the motion platform, and only a vector component of the stress is applied to the actuator and drive system. Moreover, better thermal dissipation characteristics are provided by the distribution of the unit of motion at the motion platform across a longer run of the carriage resulting in less errors in position caused by thermal expansion at the actuator and drive system. It will be appreciated by those of skill in the art that the fixed length leg can be composed of a material having a suitably low coefficient of thermal expansion.

Finally, because of the third feature, a surprising increase in off-axis stiffness has been discovered. It has been shown that the contribution of the passive leg to the transverse stiffness of the mechanism is 10 (ten) times of that of the stiffness of the passive leg itself. Current PKMs with a passive link did gain improvements of the global stiffness of the structure over mechanisms without the passive link. In comparison with existing PKMs that include a passive leg (e.g. Tricept, Georg V, etc.) that is connected to the base with a universal joint, the motion platform does not remain centered when in use, adding complexity to the control system, in some cases requiring additional motion stages. Furthermore the contribution of the passive leg in increasing the global stiffness of the mechanism is roughly five times the stiffness of the passive link itself. In contrast, simulations have demonstrated that substantially ten times the stiffness of the passive link is conferred to the motion platform. Another disadvantage of passive legs that do not center the motion platform is the limited accuracy of the passive leg: as the universal joint is installed in the base, in heavy load applications the joint may be subject to a very high torque transmitted from the tool, decreasing the accuracy of passive leg, or requiring a heavier, and stronger joint.

### BRIEF DESCRIPTION OF THE DRAWINGS

A better understanding of the invention is made possible by the following detailed description of the invention in conjunction with the following drawings, in which like reference numerals identify like features:

FIG. 1 is a static vector diagram showing operation of a first embodiment of the invention;

FIGS. 2a and 2b are schematic illustrations of an embodiment of a PKM according to the static vector diagram of FIG. 1;

FIGS. 3a and 3b are schematic illustrations of the PKM shown in FIGS. 2a,b with a tool mounted to the assembly;

FIG. 4 is a schematic illustration of a 5 degree of freedom PKM incorporating the PKM shown in FIGS. 2a,b;

FIG. 5 is a schematic partial illustration of a second embodiment of a PKM in accordance with the invention showing guideways having different angles to a base x-y plane;

FIG. 6 is a schematic partial illustration of a third embodiment of a PKM in accordance with the invention wherein the guideways are not arranged in a rotationally symmetric manner;

FIG. 7 is a schematic partial illustration of a fourth embodiment of a PKM in accordance with the invention wherein the guideways are arranged in a concave, rotationally symmetric manner;

FIG. 8 is a schematic partial illustration of a fifth embodiment of a PKM in accordance with the invention wherein a passive kinematic link is actuable to expedite motion of a motion platform;

FIG. 9 is a schematic illustration of a ball screw drive system for active kinematic chains in accordance with the invention;

FIG. 10 is a schematic illustration of a linear motor drive system for active kinematic chains in accordance with the invention;

FIG. 11 is a schematic illustration of a substitute spherical joint for the PKM shown in FIGS. 2a,b; and

FIG. 12 is a schematic illustration of a substitute universal joint for the PKM shown in FIGS. 2a,b.

### DETAILED DESCRIPTION OF THE EMBODIMENTS

The invention provides a Parallel Kinematic Machine (PKM) for controlling position and orientation of a motion platform that provides improvements in stiffness and accuracy throughout a wider range of motions, positions and orientations than provided in the prior art, with lower cost and lower stiffness kinematic links.

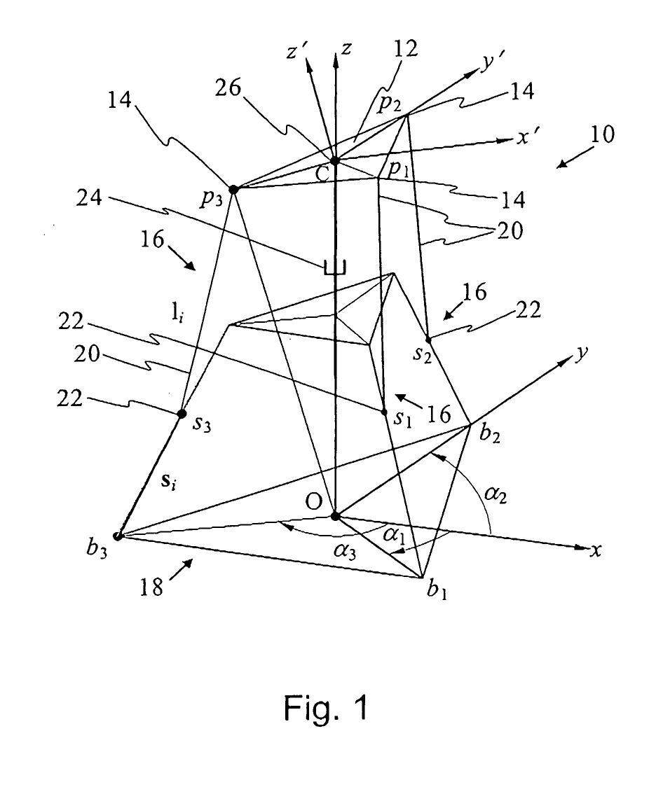

FIG. 1 is a static vector diagram of a PKM 10 in accordance with an embodiment of the invention for controlling position and orientation of a motion platform 12. At each of three (preferably maximally separated) points (p₁, p₂, p₃) on the motion platform 12, there is a corresponding spherical joint 14 which serves to couple the motion platform 12, via a respective kinematic chain 16, to a base 18. Each kinematic chain 16 includes: a sliding, fixed-length leg 20 coupled at one end to the motion platform 12 by the spherical joint 14 at a corresponding point pᵢ, and at an opposite end, by a universal joint 22 that is constrained to move along a respective guideway (b₁s₁, b₂s₂, or b₃s₃) of the base 18. As will be apparent by inspection of FIG. 1, the guideways illustrated are linear, and rise as edges of a pyramid from a plane of the base converging upwards towards the motion platform 12. An axis (z) of the PKM connects a center C of the motion platform 12 with a center O of the base 18. Each guideway rises at a same angle to the base (x-y) plane as it approaches the z axis in the illustrated embodiment. The guideways b₁s₁, and b₂s₂ are separated by angle α₁ plus 90 degrees (α₂), and (b₁s₁, and b₃s₃) are separated by an angle α₃ minus α₁. In a rotationally symmetric embodiment α₃−α₁=α₁+α₂=120 degrees, however it will be appreciated that the kinematic chains 16 need not be arranged in a rotationally symmetric manner.

Each kinematic chain 16 includes the spherical joint 14 with three degrees of freedom, the universal joint 22 with two degrees of freedom and an actuable sliding mechanism with one degree of freedom. The sliding mechanism is actuable by virtue of a controlled motion device.

A passive (i.e. not independently actuable in use) telescoping leg (via prismatic joint 24) is rigidly secured to the base 18 at one end, and coupled by a universal joint 26 to the motion platform 12. The passive telescoping leg improves a stiffness of the PKM 10, and retains a point of the motion platform 12 on the z axis, simplifying control of the position and orientation of the motion platform 12.

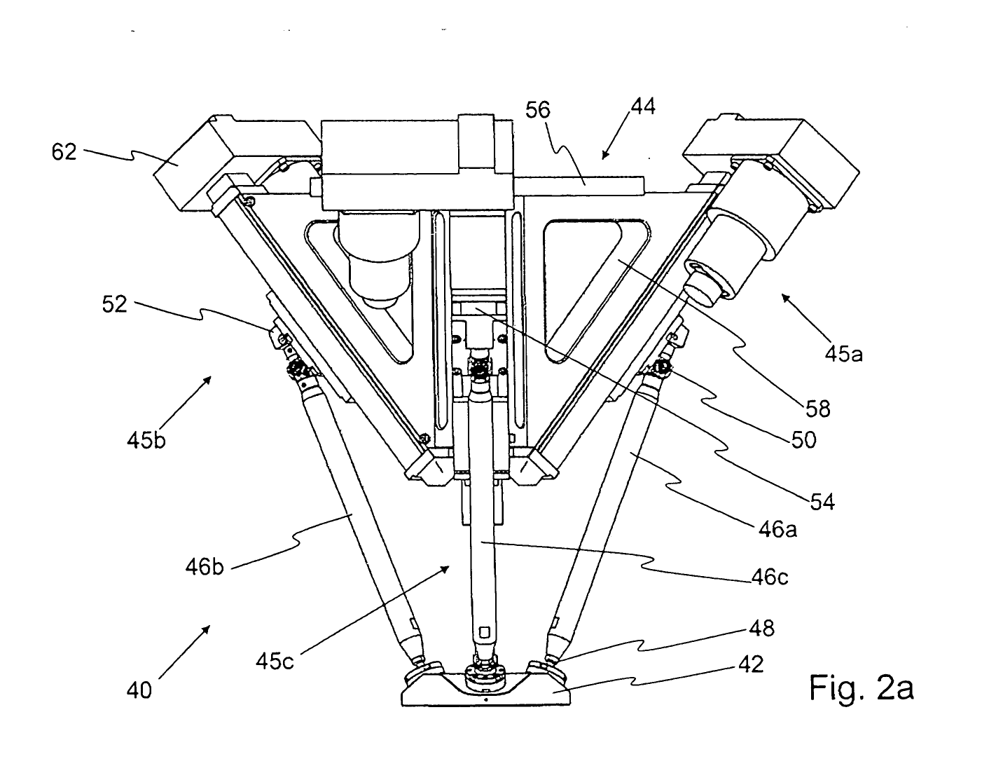

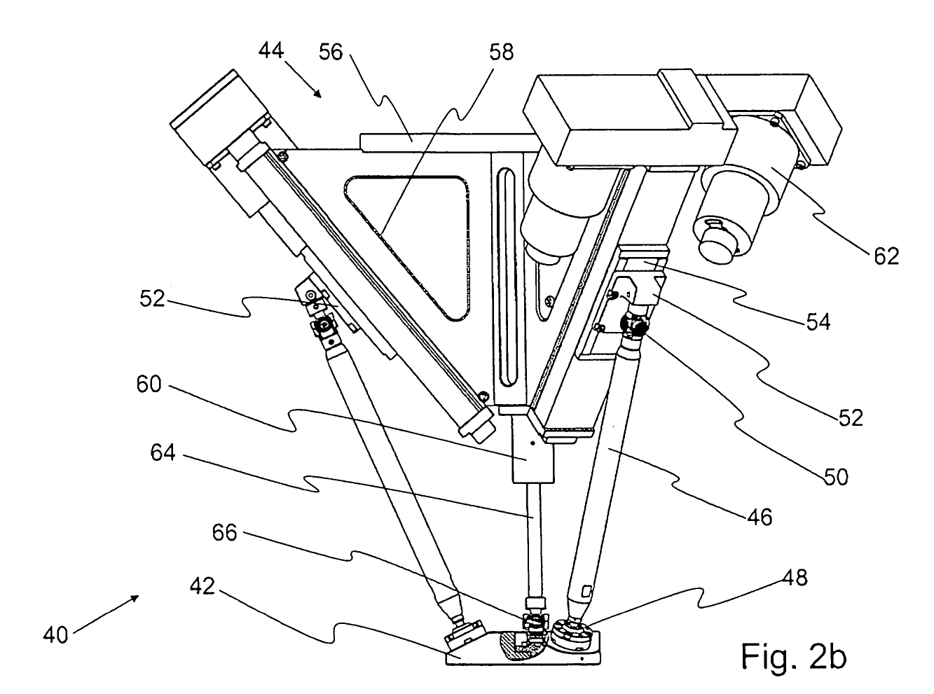

FIGS. 2a,b schematically illustrate two views of a parallel kinematic machine (PKM) 40 in accordance with an embodiment of the present invention. The PKM 40 is designed to control position and orientation of a motion platform 42, with three degrees of freedom: tilting in two directions with respect to a plane parallel to the base plane (defined by a mounting disk 56) passing through a center point of the motion platform; and raising and lowering of the motion platform in the axial (z) direction (defined by a passive leg 64). The motion platform 42 is secured to a base 44 by three active kinematic links 45a,b,c, which, in the current embodiment, are similar.

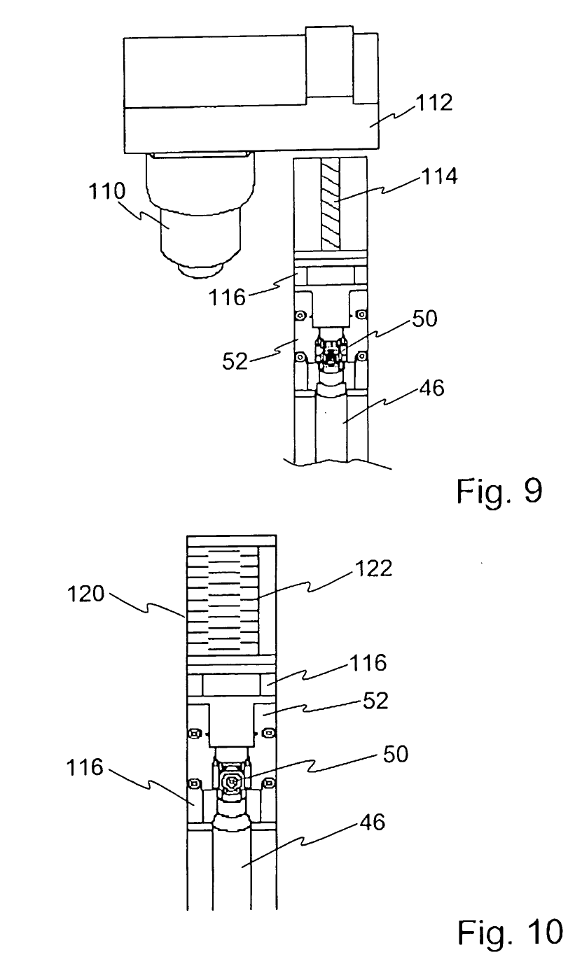

Each active kinematic link 45 has a fixed-length leg 46(a,b,c) having at a plate-connecting first end, a ball tip 48 for spherical, jointed coupling within a respective cavity on the motion platform 42; and at an opposite, second end, a universal coupling 50. Each universal coupling 50 attaches the second end to a carriage 52 that is captively held within a respective guideway 54 that is rigidly mounted to the base 44. The base 44 includes a mounting disk 56, and three right-angled triangular brace structures 58. Each brace structure 58 has an adjacent side affixed to the mounting disk 56, an opposite side affixed to an axially elongated hub 60, and a hypotenuse side defining a wall for supporting a respective guideway 54 and a motor and linear actuator 52, such as a ball screw linear actuator well known in the art, although it will be appreciated that other motion controlled systems can equally be used in accordance with the invention, including hydraulic or pneumatic driven force applicators, belt or tape type conveyers, and other known systems. Drive systems are further discussed below with respect to FIGS. 9, 10.

Each guideway 54 is therefore rigidly secured to a respective wall, and is spatially arranged so that the motion of the carriage 52 is co-planar with the axis of the PKM 40. As shown, the guideway 54 is supported at an angle with respect to the x-y plane of the base 44 that rises towards the axis so that the guideways 54 are arranged as edges of a pyramid. In order to improve accuracy and rigidity, the guideway 54 is not directed parallel to the fixed-length leg 46. Rather the fixed length leg 46 is oblique to the direction of motion of the guideway 54.

The axially elongated hub 60 supports an axially extended passive leg 54 (shown in FIG. 2b). Passive leg 54 has a prismatic joint for telescoping connection to the hub 60 of base 44, and is connected by a universal joint 66 connected to the motion platform 42. Passive leg 54 is a passive kinematic chain that confines a center point of the motion platform 42 to the axis of the PKM 40; prevents rotation of the motion platform 42 about the axis defined by the passive leg 54; and significantly increases an off-axis stiffness of the motion platform 42. Applicant has discovered that in this configuration ten times the stiffness of the passive leg is conveyed to the motion platform 42, whereas in embodiments where the passive leg is rigidly secured to the motion platform 42, only about five times the stiffness of the passive leg is conferred onto the motion platform 42.

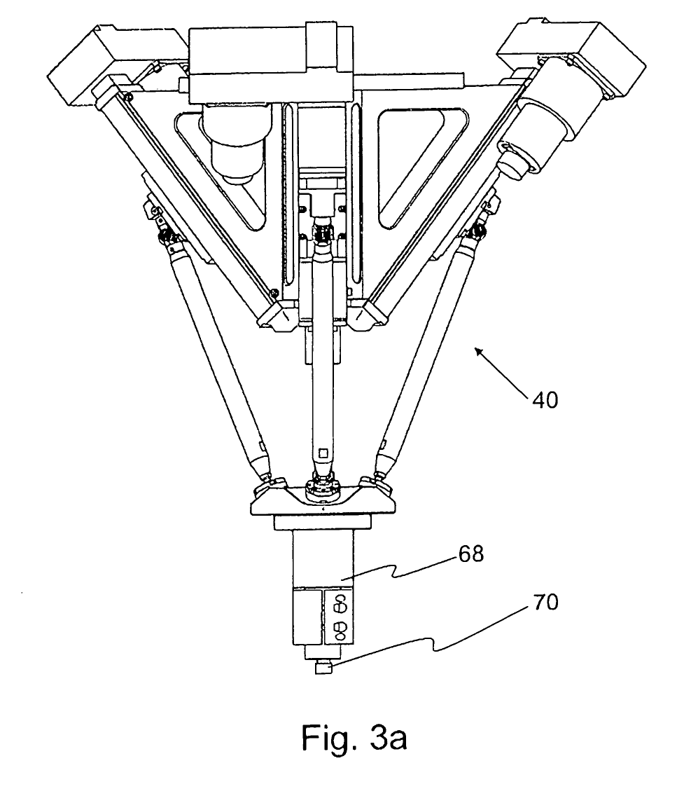

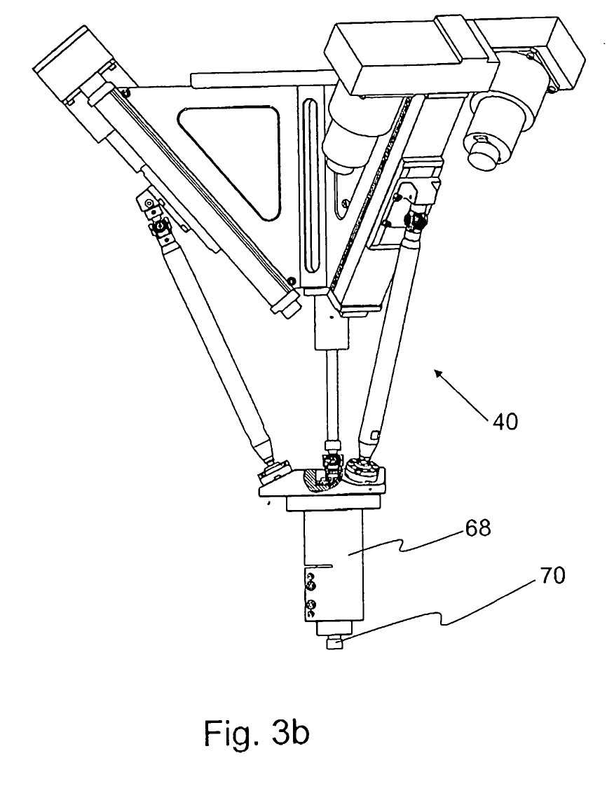

FIGS. 3a,b show a tool 68 mounted to the motion platform 42, the tool 68 having a contact surface 70 for machining purposes. As shown the tool 68 is a spindle used for boring processes, the spindle having a motor and axle, and the contact surface is a collet for selectively retaining a bit, in a manner well known in the art. It will be appreciated that the tool could alternatively be a gripper, sensor, actuator, paint gun, polishing, or grinding tool, etc.

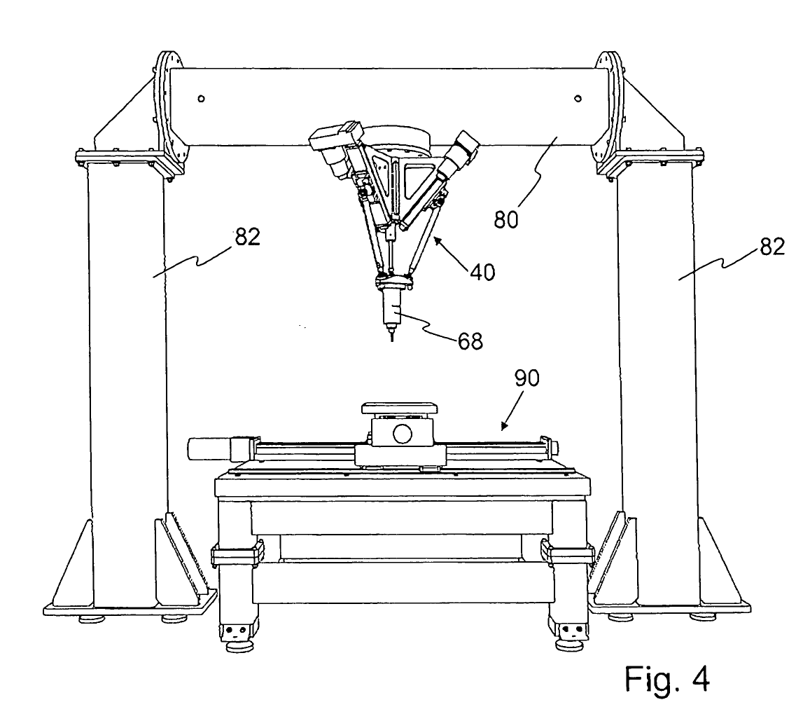

FIG. 4 schematically illustrates a 5-degree of freedom (DOF) motion control system which includes a 3-DOF PKM 40 as shown in FIGS. 1-3b, mounted on a beam 80 that is axially orientable, so that the PKM 40 may be oriented vertically downward (as shown), horizontally, or at an intermediate angle. The orientable beam 80 is rotatably supported by end blocks on a pair of pillars 82. The motion control system also includes an x-y table 90 well known in the art that provides two DOF for moving a workpiece in two directions. The x-y table 90 is adapted to receive extensions for increasing a height of a top of the x-y table 90. The x-y table 90 may be secured to the pillars 82. Preferably a common controller is used to facilitate coordination of motion of the x-y table 90 and the positions of the carriages 52 of the PKM 40, in a manner well known in the art.

It will be appreciated that each of the three active kinematic chains may be of a different composition and/or configuration. If highly directed stiffness is required in one direction within a limited range of orientations, and in other directions a greater range of motion is required, for example, one or more of the active kinematic chains may be of different composition. In such embodiments it may be suitable to arrange the kinematic chains in a direction that converges on the motion platform, but not from rotationally symmetric directions (i.e. not 120 degrees angular separation between each kinematic chain in a nominal position of the motion platform).

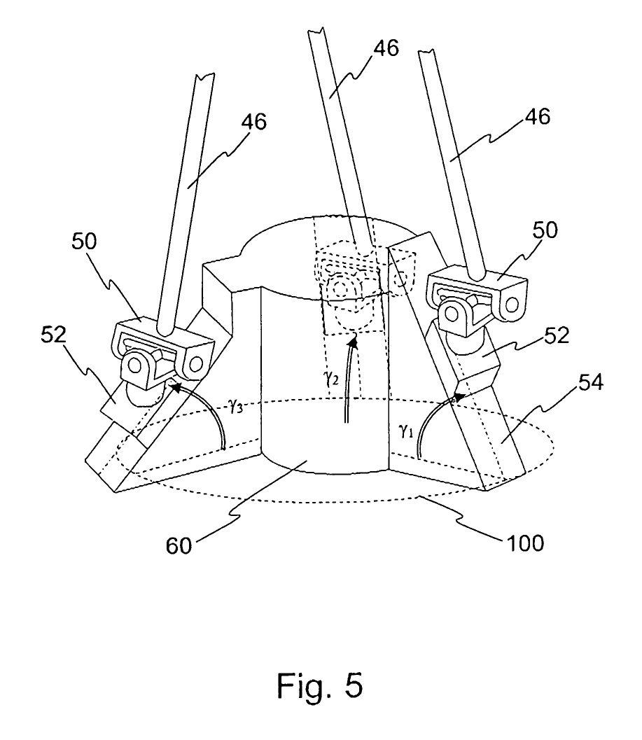

FIG. 5 schematically illustrates an embodiment of a PKM 40 that is different from that of FIGS. 2a,b in that the three kinematic chains 15 are (the passive leg 54 is not illustrated) of a same constitution, but they are not provided at a same (minimum) angle with respect to a base plane 100. Rather, each guideway 54 is supported at a different respective angle (γ₁,γ₂, γ₃) with respect to the base plane 100. Specifically γ₁<γ₂<γ₃. The guideways 24 are supported by differently sloped walls connected to the hub 60. The illustrated embodiment shows variance of the angle by changing a (z-coordinate) point of intersection of the sloped walls with the hub 60, and with a radial distance of the bottom of the sloped wall. Such an arrangement provides different stiffness profiles for the motion platform (not shown).

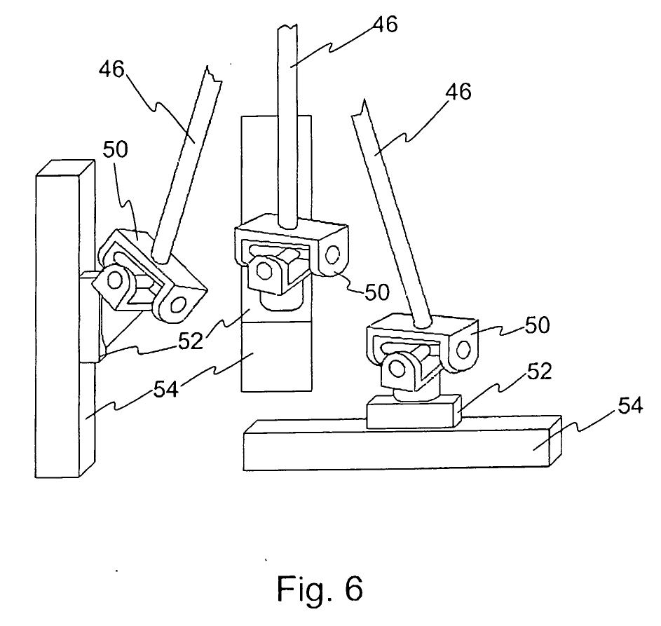

FIG. 6 schematically illustrates an embodiment of a PKM 40 that is different from that of FIGS. 2a,b in that guideways 54 are not radially disposed, and accordingly the guideways 54 are not coplanar with the axis of the PKM 40. The guideway 54 of one active kinematic chain 15 is disposed horizontally, the guideway 54 of a second active kinematic chain 15 is disposed vertically, and the third is disposed at an intermediate angle between the two. While restraining the motion of the carriage 52 to a plane that includes the axis is a natural choice, to minimize torsion on the motion platform 42, it is not necessary. Furthermore the guideway 54 need not be linear, although this may simplify construction and design, and permits commercially available equipment to be used.

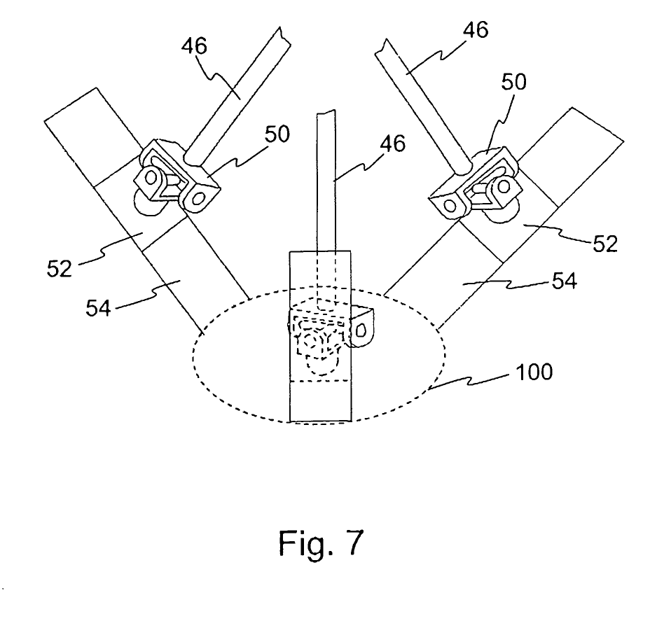

FIG. 7 schematically illustrates a further configuration for the three guideways 24. In this configuration all of the angles are sloping in an opposite direction as shown in FIGS. 2a-3b. It will be appreciated by those skilled in the art that with a concave arrangement of the guideways 24 (i.e. having a greater radial extent moving away from the base plane 100 from the axis) an inverse of the stiffness map of the PKM 40 with a convex arrangement of guideways 24, is achieved.

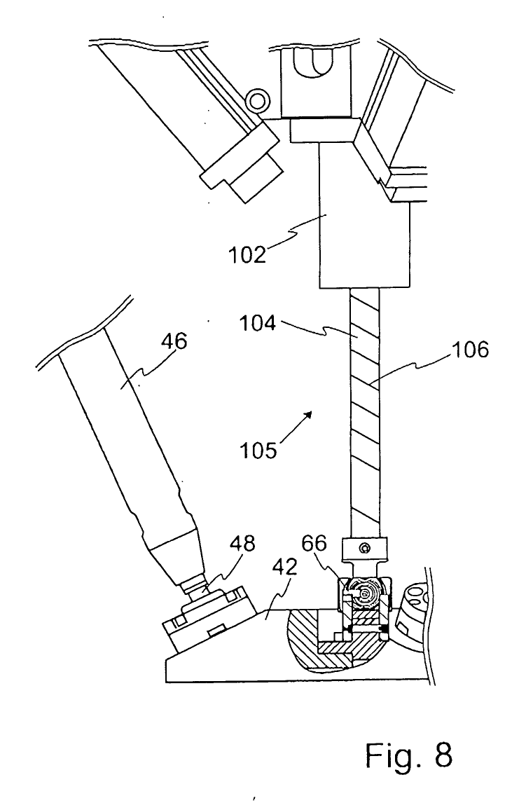

FIG. 8 schematically illustrates an embodiment of a PKM 40 that is different from that of FIGS. 2a,b in that, instead of the passive leg 64, an actuable prismatically jointed leg 105 is provided. While this prismatically jointed leg 105 does not add a degree of freedom to the motion platform 42, it facilitates motion of the motion platform 42, and can lead to faster transitions between desired positions and orientations. Accordingly, the actuable prismatically jointed leg 105 is driven as a function of the motion of the carriages 52, and care is taken to prevent application of conflicting forces on the motion platform 42. It will be appreciated that the same higher resultant off-axis stiffness of the motion platform is provided regardless of whether the prismatically jointed leg 105 is driven or passive (i.e. leg 64), but the on-axis stiffness may be improved by a resistance the drive system provides in the axial direction. The prismatically jointed leg 105 includes a linear drive system (in this case a ball screw drive system 102 well known in the art), and a threaded rod 104 which has (schematically shown) threads 106 for engaging ball bearings of the ball screw drive system 102 (not shown). It will be appreciated that precise control over the ball screw drive system 102 and the positions of the carriages 52 in the respective guideways 54, jointly, are essential to preventing the motion platform from seizing up, and applying stresses to the motion platform 42 and kinematic chains 45.

FIG. 9 schematically illustrates the drive system for the kinematic chains 15 shown in FIGS. 2a-3b. The drive system includes a motor 110, a housing 112 for a belt driven coupler that couples the motor's axle to a ball screw linear actuator. It will be appreciated that a gear box or other coupler could equally be used instead of the belt coupler. By revolving a nut that is coupled by ball screws to a threaded rod 114, the threaded rod 114, which is secured against axial rotation by a rigid connection to the carriage 52 in the guideway 54, is forced to axially reciprocate within the housing 112. In this way the threaded rod 114 is driven to move the carriage 52 along a path defined by the guideway 54. The guideway 54 includes a pair of tracks 116 on which the carriage 52 rolls in the illustrated embodiment.

FIG. 10 schematically illustrates an alternative embodiment of a drive system for the kinematic chains 45. The drive system comprises a linear motor 120 which has a track of magnets 122 disposed on an underside. A forcer is used to directly move the carriage 52 along the track 122 of the linear motor 120 in a manner well known in the art.

It will be appreciated that other drive systems (hydraulic, pneumatic, etc.) could alternatively be used as suitable for a particular application.

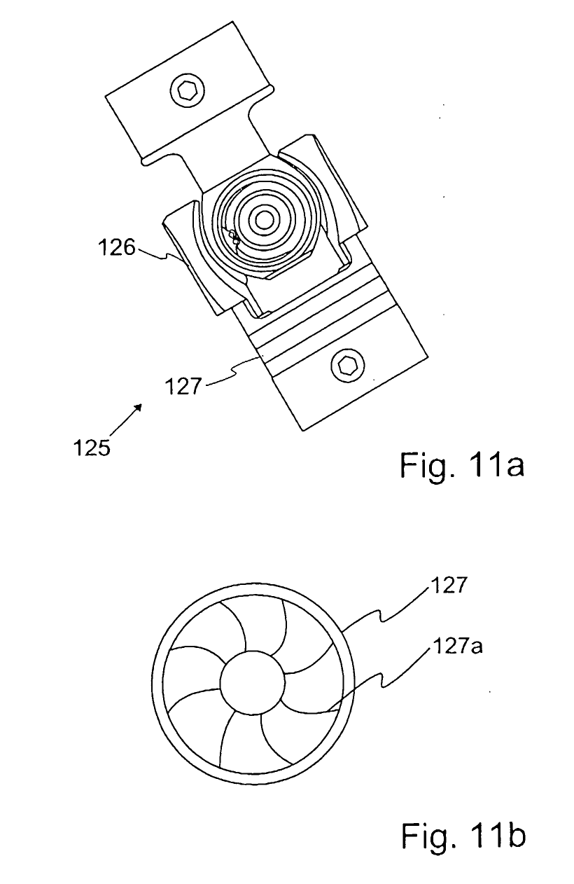

FIG. 11 schematically illustrates 3-DOF joint 125 alternative to a spherical joint that is effective when a small amount of torsion (revolution about an axis of the coupling) is required. The 3-DOF joint 125 comprises a universal connector 126 coupled to a compliant radial bearing 127. The universal connector 126 permits rotation in two orthogonal axes perpendicular to the axis of the coupling, and the compliant radial bearing 127 permits limited torsional movement of the 3-DOF joint 125. The compliant radial bearing 127 consists of a series of flexible spokes 127a joining inner and outer raceways of the compliant radial bearing 127 that allows for small amounts of torsion while maintaining a high degree of stiffness.

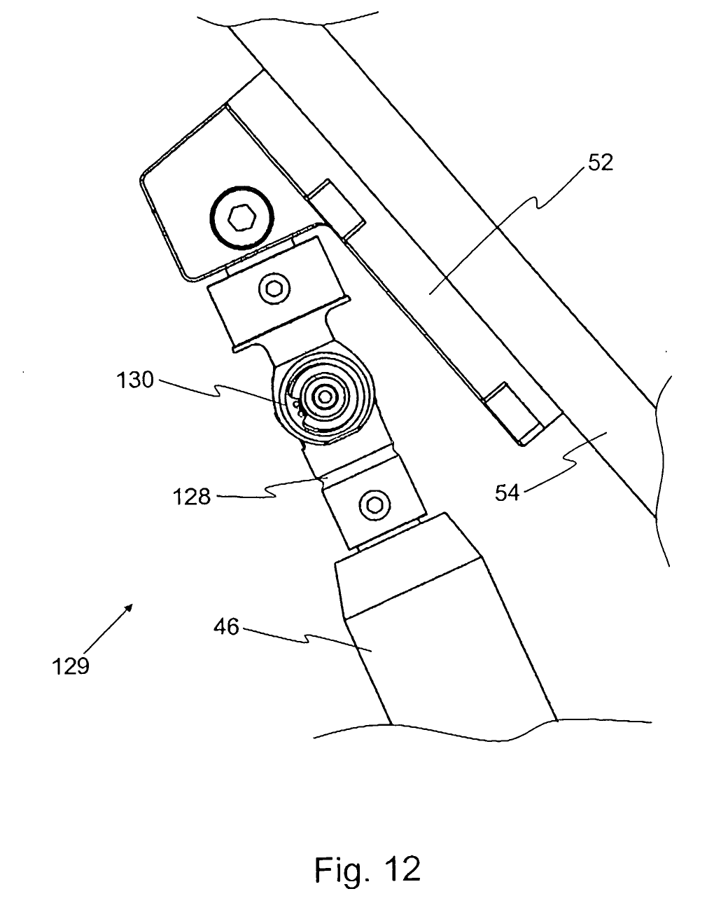

FIG. 12 schematically illustrates a 2-DOF joint 129 consisting of a compliant revolute joint alternative to a universal joint that is effective when only a small amount of bending is required. The 2-DOF joint 129 includes a revolute joint 130 and a complaint section 128 that permits bending at a minor angle.

Joints such as 3-DOF joint 125 and 2-DOF joint 129 are particularly useful when the arrangement of the guideways 54 ensure only a minimal angle of deflection in one direction. It will be understood that other means of providing joints having the effective DOF required can be produced using compliance of the fixed-length leg 46, or other pieces, for example.

1. A parallel kinematic machine (PKM) for controlling position and orientation of a motion platform, the PIKM comprising a base structure, three active kinematic chains, a prismatically jointed leg, and a motion platform, wherein:
each of the three active kinematic chains consists of a fixed length leg coupled at a first end by an effectively spherical joint to a respective point on the motion platform, and coupled at a second end to a carriage slidably mounted to the base structure;
the prismatically jointed leg is coupled at one end to a motion platform by an effectively universal joint, and rigidly secured to the base structure;
the base structure secures one drive motor, one actuator, and one guide for each of the active kinematic chains, each actuator being coupled to the corresponding carriage that is slidably mounted to the corresponding guide, which guide constrains the carriage to move in a direction oblique to a direction of motion of the corresponding fixed length leg.

2. The PKM as recited in claim 1 wherein each active kinematic chain is of a same configuration and composition.

3. The PKM as recited in claim 1 wherein the active kinematic chains are disposed with radial symmetry about an axis concentric with the prismatically jointed leg extending between the motion platform and the base structure.

4. The PKM as recited in claim 1 wherein each guide defines a linear path and each actuator is a linear actuator.

5. The PKM as recited in claim 1 wherein each actuator is a ball screw linear actuator.

6. The PKM as recited in claim 1 wherein each actuator is a linear motor.

7. The PKM as recited in claim 3 wherein at least one of the guides defines a linear path that is coplanar with the axis.

8. The PKM as recited in 3 wherein each guide defines a path that is parallel to the axis.

9. The PKM as recited in claim 1 wherein at least one of the effectively spherical joints is a ball joint.

10. The PKM as recited in claim 1 wherein at least one of the effectively spherical joints is a torsionally compliant universal joint.

11. The PKN as recited in claim 1 wherein at least one of the effectively universal joints is a universal joint.

12. The PKM as recited in claim 1 wherein at least one of the effectively universal joints is a compliant revolute joint.

13. The PKM as recited in claim 1 wherein the respective points on the motion platform are substantially maximally separated.

14. The PKM as recited in claim 1 wherein the base structure includes a set of structural members that interconnect a mounting plate, three walls for supporting the respective guides, actuators and motors, and an axial point of the base at which the prismatically jointed leg is prismatically mounted.

15. The PKM as recited in claim 14 wherein the set of structural members comprise spoke members secured to a hub that is coaxial with the prismatically jointed leg.

16. The PKM as recited in claim 1 wherein the base structure is mounted above a jointly controlled motion table.

17. The PKM as recited in claim 1 wherein the base structure is mounted on a support frame at one of various angles permitting coarse-grain direction of the motion platform.

18. The PKM as recited in claim 1 wherein the prismatically jointed leg further comprises an actuator, making the prismatically jointed leg an active leg, the actuator being jointly controlled with the actuators of the kinematic chains.

19. The PKM as recited in claim 1 wherein the motion platform further comprises one of a tool and an adapter for coupling to a tool.

20. An active kinematic chain for connecting a motion platform to a base in a parallel kinematic machine (PKM), the active kinematic chain comprising:
an actuable sliding carriage constrained to move in a guide, the guide and a drive system being rigidly secured to the base;
an effective universal joint coupling the carriage to a first end of a fixed-length leg; and
an effectively spherical joint coupling the fixed-length leg to the motion platform.

21. A PKM comprising three active kinematic chains of claim 20 connected to the motion platform at maximally separated points, and a prismatically jointed leg axially connecting a center of the motion platform to a center of the base, the jointed leg being rigidly secured to the base and coupled by an effective universal joint to the motion platform.

22. A parallel kinematic machine (PKM) for controlling position and orientation of a motion platform, the PKM comprising:
a base structure having a mounting plate defining a base plane of the PKM, and three inclined surfaces symmetrically disposed around an axis passing orthogonally through the base plane, each of the inclined surfaces extending from the planar mounting plate towards the axis at a fixed angle from the base plane;
a prismatically jointed leg connected to the motion platform by an effectively universal joint, the prismatically jointed leg lying on the axis and providing a free prismatic joint for telescopingly connecting a centre point of the motion platform to the base structure; a plurality of contact points on the rigid frame, the plurality of contact points designed to rigidly secure the supported ends of the kinematic chains to the frame so that the kinematic chains extend into the concavity;
three active kinematic chains connected to the motion platform by respective, effectively spherical joints at respective distant points on the motion plate, each of the active kinematic chains including:
a linear actuator and drive means coupled to control motion of a carriage in a guide, the guide, linear actuator and drive means being statically coupled to a corresponding one of the inclined surfaces; and
a fixed-length leg having a first end coupled to the carriage by a joint that is effectively equivalent to a universal joint, and a second end providing the connection to the motion platform.
